(19) United States
(12) Patent Application Publication
(10) Pub. No.: US 2004/0103572 A1
(43) Pub. Date: Jun. 3, 2004

(54) Advertising

(76) Inventor: Navandra Adiah Naidu, Johannesburg (SA)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/469,168

(22) PCT Filed: Feb. 27, 2002
(86) PCT No.: PCT/IB02/00572

(30) Foreign Application Priority Data
Feb. 27, 2001 (ZA) 2001-1635

(51) Int. Cl. G09F 7/12

(52) U.S. Cl. 40/594

(57) ABSTRACT

This invention relates to a handrail (10) for a moving walkway, escalator, or the like, the handrail (10) comprising an endless strip (12) of a flexible polymeric material, the strip (12) having an inner side (14) shaped for engagement with a handrail support, and the strip (12) having an outer surface (18) on the side of the strip (12) opposite its inner side (14); advertising matter (24) replaceably carried by the outer surface (18) of the strip (12); and a flexible sheet (16) replaceably adhesively secured to the outer surface (18) of the strip (12), the sheet (16) being exposed to the atmosphere. The sheet (16) permits viewing by persons supported on the moving walkway, escalator, or the like of the advertising matter (24), and the sheet (16) permits replacement of the advertising matter (24).

This invention relates to advertising. In particular, it relates to a handrail for a moving walkway, escalator, or the like.

According to one aspect of the invention, there is provided a handrail for a moving walkway, escalator, or the like, the handrail comprising:

an endless strip of a flexible polymeric material, the strip having an inner side shaped for engagement with a handrail support, and the strip having an outer surface on the side of the strip opposite its inner side;

advertising matter replaceably carried by the outer surface of the strip; and

a flexible sheet replaceably adhesively secured to the outer surface of the strip, the sheet being exposed to the atmosphere, the sheet permitting viewing by persons supported on the moving walkway, escalator, or the like of the advertising matter, and the sheet permitting replacement of the advertising matter.

The term “advertising matter” as used herein includes any marking of an advertising, instructive, or like nature, including printed images such as advertisements, logos, brand names, trade marks, trade mark devices, instructions, or the like.

In a particular embodiment of the invention, the sheet comprises a single film bearing the advertising matter, the film being in contact with the strip, to which it is adhesively secured, and the film being exposed to the atmosphere.

The film may be self-adhesive. The term “self-adhesive” as used herein means that an adhesive is applied to the film during manufacturing of the film and not when the sheet is applied to the strip.

Instead, the sheet may comprise an inner film bearing the advertising matter and a transparent cover film covering the inner film, the films being arranged face-to-face, so that the inner film is sandwiched between the cover film and the outer surface of the endless strip, at least the cover film, alongside the periphery of the inner film, being adhesively secured to the endless strip.

The cover film may be self-adhesive. Conveniently, the self-adhesive film is pressure-sensitive. The term “pressure-sensitive” as used herein means that the film is provided with an adhesive that does not act as an adhesive when relatively light pressures are applied to it, the adhesive becoming adhesively active in response to the application of a pressure, larger than a threshold pressure, thereto.

The self-adhesive film may have an adhesive which is solvent-based. The term “solvent-based” as used herein means that the adhesive, when the sheet is adhesively secured to the outer surface of the strip, comprises a solvent which then evaporates, subsequent removal from the strip of the adhesive and film by means of the solvent thus being permitted.

While the sheet may extend longitudinally along substantially the entire length of the endless strip, the sheet preferably extends along only part of the length of the endless strip.

The sheet may cover part of the width of the outer surface of the endless strip, or the full width thereof.

According to another aspect of the invention, there is provided a method of advertising which includes the step of adhesively securing a flexible sheet to an outer surface of a strip of a flexible polymeric material for forming an endless handrail of a moving walkway, escalator, or the like, the sheet being replaceably adhesively secured to the strip such that the sheet is exposed to the atmosphere, the sheet securing the advertising matter to the strip such that the advertising matter is replaceable and is visible to persons supported on the moving walkway, escalator, or the like.

The invention will now be further described and illustrated, by way of example, with reference to the accompanying diagrammatic drawings, in which:

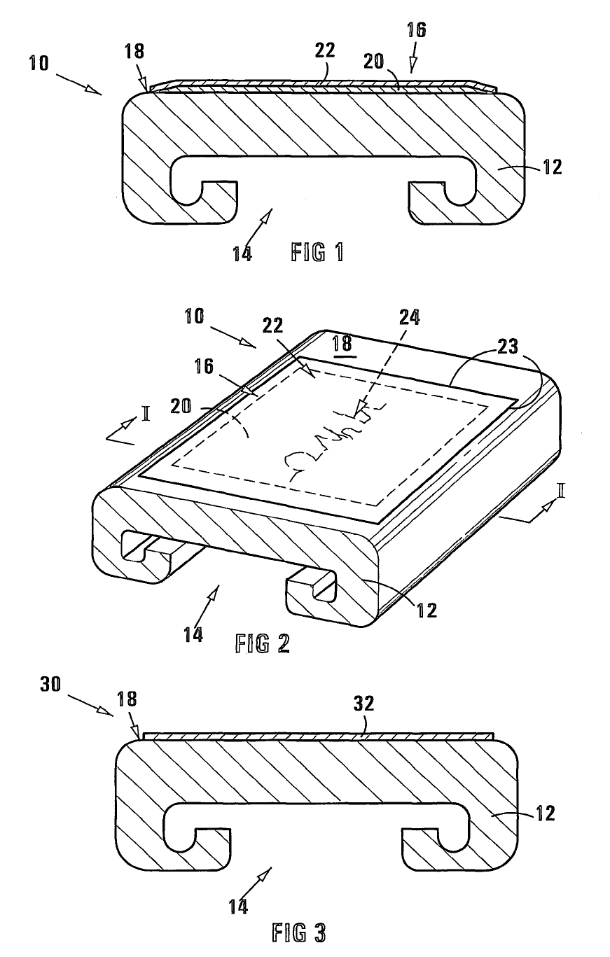

FIG. 1 is a schematic cross-sectional view of a handrail in accordance with the invention, taken at line I-I in FIG. 2;

FIG. 2 is a schematic three-dimensional view of a part of the handrail of FIG. 1; and

FIG. 3 is a view corresponding to FIG. 1 of a further embodiment of a handrail in accordance with the invention.

In FIGS. 1 and 2, reference numeral 10 generally indicates a handrail in accordance with the invention for an escalator (not shown). The handrail 10 includes an endless strip 12 of a flexible polymeric material. In conventional fashion, the strip 12, in use, extends along a handrail support (not shown) which extends alongside a forwardly moving leg of an elongated endless moving support surface (not shown) provided by the escalator, the handrail support guiding the endless strip 12 in an endless course having an upper leg in which the strip 12 moves in the same direction as the forwardly moving leg of the support surface, the strip 12 being vertically spaced from the support surface so that the strip 12 forms a handrail for persons (not shown) standing on the support surface.

When viewed in cross-section (FIG. 1), the strip 12 has an inwardly facing inner side 14 shaped for engagement with the handrail support. A flexible sheet 16 is adhesively secured to an outwardly facing outer surface 18 of the strip 12, the sheet 16 being exposed to the atmosphere and comprising a rectangular inner film 20 (shown in broken lines in FIG. 2) and a similarly shaped transparent cover film 22. The films 20, 22 are arranged face-to-face, so that the inner film 20 is sandwiched between the cover film 22 and the strip 12, the cover film 22 being somewhat larger than the inner film 20, so that a border portion 23 of the cover film 22, extending alongside the periphery of the inner film 20, is in contact with the strip 12 (FIG. 2).

As can be seen in FIG. 2, the sheet 16 extends along a part of the length of the strip 12 and covers the full width of a flat central part of the surface 18 of the strip 12. Both the inner film 20 and the cover film 22 are provided with a solvent-based adhesive, such that the films 22 are self-adhesive and are pressure-sensitive.

The inner film 20 displays advertising matter in the form of an advertisement 24 which is printed on the outer side of the inner film 20, facing away from the strip 12. The advertisement 24 is thus displayed such that it is visible to a person on the escalator.

In use, the sheet 16 is secured to the strip 12 by respectively positioning the films 20, 22 on the strip 12 as described, and applying pressure to the films 20, 22 so that the inner film 20 and the border portion 23 of the cover film 22 are releasably and replaceably adhesively secured to the strip 12, the cover film 22 also being adhesively secured to the inner film 20. Once thus secured, the advertisement 24 is, in use, displayed to persons on the escalator.

The sheet 16 can be removed and replaced by peeling the respective films 20, 22 from the strip 12 and removing any residual adhesive left on the surface 18 of the strip 12, e.g. by means of an appropriate solvent, removal of such residual adhesive being facilitated by the adhesive's being solvent-based.

FIG. 3 shows a further embodiment of a handrail 30 in accordance with the invention, the handrail 30 being similar to the handrail 10 shown in FIGS. 1 and 2, with the distinction that instead of a composite sheet 16, a single sheet 32 bearing advertising matter is releasably and replaceably adhesively secured to the strip 12. As before, the sheet 32 is self-adhesive, being provided with a solvent-based adhesive.

It is an advantage of the handrail 10 as described with reference to the drawings that the sheet 16, 32 can be secured to the strip 12 to display advertising matter to users of the escalator without the need for any modification of the strip 12. The sheet 16 can thus be secured to any existing strip 12 to form a handrail 10 in accordance with the invention, without detrimentally affecting normal operation of the strip 12; and the sheet 16, 32 can furthermore easily be replaced, to vary or replace the advertising matter from time to time, as desired.

1. A handrail for a moving walkway, escalator, or the like, the handrail comprising:
an endless strip of a flexible polymeric material, the strip having an inner side shaped for engagement with a handrail support, and the strip having an outer surface on the side of the strip opposite its inner side;
advertising matter replaceably carried by the outer surface of the strip; and
a flexible sheet replaceably adhesively secured to the outer surface of the strip, the sheet being exposed to the atmosphere, the sheet permitting viewing by persons supported on the moving walkway, escalator, or the like of the advertising matter, and the sheet permitting replacement of the advertising matter.

2. A handrail as claimed in claim 1, in which the sheet comprises a single film bearing the advertising matter, the film being in contact with the strip, to which it is adhesively secured, and the film being exposed to the atmosphere.

3. A handrail as claimed in claim 2, in which the film is self-adhesive.

4. A handrail as claimed in claim 1, in which the sheet comprises an inner film bearing the advertising matter and a transparent cover film covering the inner film, the films being arranged face-to-face, so that the inner film is sandwiched between the cover film and the outer surface of the endless strip, at least the cover film, alongside the periphery of the inner film, being adhesively secured to the endless strip.

5. A handrail as claimed in claim 4, in which the cover film is self-adhesive.

6. A handrail as claimed in claim 3 or claim 5, in which the self-adhesive film is pressure-sensitive.

7. A handrail as claimed in claim 3, claim 5, or claim 6, in which the self-adhesive film comprises an adhesive which is solvent-based.

8. A handrail as claimed in any one of the preceding claims, in which the sheet extends along part of the length of the endless strip.

9. A method of advertising which includes the step of adhesively securing a flexible sheet to an outer surface of a strip of a flexible polymeric material for forming an endless handrail of a moving walkway, escalator, or the like, the sheet being replaceably adhesively secured to the strip such that the sheet is exposed to the atmosphere, the sheet securing advertising matter to the strip such that the advertising matter is replaceable and is visible to persons supported on the moving walkway, escalator, or the like.
